(19) United States
(12) Patent Application Publication
(10) Pub. No.: US 2026/0203166 A1
(43) Pub. Date: Jul. 16, 2026

(54) RANK-LEVEL ECC DECODING METHOD AND APPARATUS FOR CORRECTING ROW AND COLUMN ERRORS

(71) Applicant: RESEARCH & BUSINESS FOUNDATION SUNGKYUNKWAN UNIVERSITY, Suwon-si (KR)

(72) Inventors: Sang Hyo KIM, Suwon-si (KR); Jung Rae Kim, Suwon-si (KR); Seok In Hong, Suwon-si (KR); Gyu Ri Kim, Suwon-si (KR); Tae Uk Ha, Suwon-si (KR)

(21) Appl. No.: 19/449,163

(22) Filed: Jan. 14, 2026

(30) Foreign Application Priority Data
Jan. 15, 2025 (KR) 10-2025-0006108

(51) Int. Cl. G06F 11/10; G06F 17/16

(52) U.S. Cl. CPC G06F 11/1048; G06F 11/1016; G06F 17/16

(57) ABSTRACT

A row and column error control RL-ECC decoding apparatus comprises: an RS decoder configured to receive a codeword as an input and to correct a vertical error of t symbols or less of the RS code; a horizontal error decoder configured to receive the codeword as input and to correct a horizontal error of t+1 symbols or more; and a decoding output selector configured to select, one among an output of the RS decoder and an output of the horizontal error decoder to output a decoding result of the RS decoder; wherein the decoding output selector selects the output of the RS decoder if decoding is successful, and selects the output of the horizontal error decoder if the decoding fails, and when both the output of the RS decoder and the output of the horizontal error decoder exist, the decoding output selector selects the output of the RS decoder.

### CROSS-REFERENCE TO RELATED APPLICATION

This application claims priority to Korean Patent Application No. 10-2025-0006108, filed on Jan. 15, 2025, the entirety of which is incorporated herein by reference for all purposes.

### TECHNICAL FIELD

The present disclosure relates to a rank-level ECC (error correction code) decoding method capable of correcting row and column errors, and a rank-level ECC decoding apparatus performing the decoding method.

### BACKGROUND

An ECC (error correction code) is used to detect and correct errors occurring during a data communication process by adding redundant data called parity, and for this purpose, the ECC requires encoding and decoding processes. Today, error correction codes are widely used in the field of communication to protect messages from errors and to increase the reliability of systems, and semiconductor memories have also adopted error correction codes to respond to errors which may occur during data storage and transmission processes.

A memory such as a DRAM (dynamic random access memory) is required to transmit accurate data in a short time. Early memories, where the error probability was very low and single-bit errors were the majority, either did not perform error correction or often utilized simple SEC (single error correction) codes performed for each chip; this is because the space and delay overhead for storing parity and performing encoding/decoding were considered. However, as high integration and low-power driving have progressed to improve the performance of semiconductor memories, the overall error occurrence probability has increased, and the proportion of MBU (multi bit upset) has also increased. Accordingly, to maintain memory reliability, a rank-level ECC (RL-ECC) has been applied by using additional DRAM chips.

A semiconductor memory to which RL-ECC is applied protects data chips from errors by additionally using not only data chips storing data but also parity chips for storing the parity of the error correction code.

FIG. 1 illustrates an error correction process in data transmission between a processor and a DRAM.

Data u is stored in the cells of a DRAM chip in bit units. Before being sent to the DRAM, the data is encoded by a memory controller into a codeword c, in which parity r is added to the data, and transmitted to the DRAM, and the data and parity bits are stored in a data chip and a parity chip, respectively.

When reading data stored in the DRAM, a codeword including parity is read. At this time, an error e may be added during the storage and transmission process, and a read codeword (received codeword) y=c+e may be read. This read codeword is decoded in the memory controller and transmitted to the processor as data. Through this encoding/decoding process, the reliability of the DRAM may be increased by detecting and correcting errors which may occur during the storage and transmission of data, but there is a problem in which additional storage space is required to store parity bits and a time delay occurs during the encoding/decoding process.

For RL-ECC, an error correction code such as a BCH (Bose-Chaudhuri-Hocquenghem) code or an RS (Reed-Solomon) code, which is more complex than an SEC code but capable of correcting a wider range of errors, has been applied. Among them, the RS code is an error-correcting code performing symbol-level error correction by grouping multiple bits into one symbol, is a code satisfying the Singleton bound, and has been adopted as an ECC in various applications such as broadcasting systems and memory due to the advantage of being capable of effectively responding to burst errors.

In a memory system, there are various methods for grouping the bits constituting a symbol of the RS code. In particular, Bamboo ECC, a method of forming one symbol from a plurality of bits output from a single pin, has the characteristic of being robust against pin-level errors while also providing chipkill correction capability to correct all errors occurring in a chip when two DRAM chips with four DQ pins (×4 chips) are used as parity chips, making it capable of effectively responding to error situations caused by defects in DRAM chips and pins. Here, chipkill refers to the capability to correct all error patterns confined to a single chip.

However, when one ×8 chip is used as a parity chip, the amount of parity is the same, but chipkill correction capability cannot be guaranteed. In particular, a horizontal error (an error occurring in the row direction of the RS code's codeword array), where errors occur simultaneously on multiple pins of a single DRAM chip, may cause errors which are uncorrectable by memory ECC using the RS code of the Bamboo ECC scheme. As one type of such horizontal error, there is an error caused by an abnormality in the DQS (DQ strobe) signal, which determines the moment the pins read data in a DRAM chip, and the tendency for such errors to occur is increasing as the operating clock of DRAM continues to rise in response to recent high computing demands. In this document, such an error will be referred to as a DQS error. Therefore, a technology is required to additionally correct DQS errors occurring in this horizontal direction.

### SUMMARY

According to an embodiment, a rank-level ECC decoding apparatus and a method thereof are provided for correcting a vertical error (an error occurring in the column direction of the RS code's codeword array) and a horizontal error based on an RS code.

The problems to be solved by the present disclosure are not limited to those mentioned above, and other unmentioned problems will be clearly understood by those of ordinary skill in the art from the following description.

A row and column error control RL-ECC decoding apparatus according to a first aspect comprises: an RS decoder configured to receive a codeword as an input and to correct a vertical error of t symbols or less of an RS code; a horizontal error decoder configured to receive the codeword as input and to correct a horizontal error of t+1 symbols or more; and a decoding output selector configured to select, based on a decoding result signal, one among an output of the RS decoder and an output of the horizontal error decoder to output a decoding result of the RS decoder; wherein the decoding output selector selects the output of the RS decoder if the decoding result signal represents that decoding is successful, and selects the output of the horizontal error decoder if the decoding result signal represents that the decoding fails, and when both the correction result for the vertical error and the correction result for the horizontal error exist, the decoding result signal represents that the decoding is successful so that the decoding output selector the decoding output selector selects the output of the RS decoder to output the decoding result.

A row and column error control RL-ECC decoding method to be performed by a row and column error control RL-ECC decoding apparatus according to a second aspect comprises: receiving a codeword as input and correcting a vertical error of t symbols or less of an RS code; receiving the codeword as input and correcting a horizontal error of t+1 symbols or more; and selecting, based on a decoding result signal, one among a correction result for the t symbols or less and a correction result for the t+1 symbols or more to output a decoding result; wherein, when outputting the decoding result, if the decoding result signal represents that decoding is successful, the correction result for the vertical error is selected as the decoding result, if the decoding result signal represents that the decoding fails, the correction result for the horizontal error is selected as the decoding result, and when both the correction result for the vertical error and the correction result for the horizontal error exist, the decoding result signal represents that the decoding is successful so that the correction result for the vertical error is selected as the decoding result.

A computer program of a non-transitory computer-readable storage medium according to a third aspect, on which the computer program is stored, when executed by a processor, comprises instructions for causing the processor to perform the row and column error control RL-ECC decoding method.

A computer program of a non-transitory computer-readable storage medium according to a fourth aspect, on which the computer program is stored, when executed by a processor, comprises instructions for causing the processor to perform the row and column error control RL-ECC decoding method.

According to the above aspects, a rank-level ECC decoding apparatus and a method thereof are provided, capable of correcting a vertical error and a horizontal error based on an RS code. According to the above aspects, horizontal errors may be corrected while maintaining a conventional encoding process by using a polynomial syndrome of an RS code and a result of a polynomial modulo operation. Horizontal errors may be additionally controlled in addition to the vertical error correction capability of a conventional RS code without additional parity and time delay. By correcting horizontal errors within one chip using an RS code without using a syndrome-error pattern mapping table, the horizontal error decoder may be operated in parallel with a conventional RS code decoder, and as a result, horizontal errors within one chip may be additionally corrected without additional parity or time delay.

### BRIEF DESCRIPTION OF THE DRAWINGS

FIG. 1 is a diagram illustrating an error correction process in data transmission between a processor and a DRAM.

FIG. 2 is an example of an RS code design for an RL-ECC using Bamboo ECC.

FIG. 3 is an example of a horizontal error caused by a DQS signal abnormality.

FIG. 4 is a block diagram of a row and column error control RL-ECC decoding apparatus according to an embodiment of the present disclosure.

FIG. 5 is a detailed block diagram of the horizontal error correction decoder shown in FIG. 4.

FIG. 6 is a Venn diagram of a target error pattern set for correction.

FIG. 7 illustrates the polynomial syndrome characteristics of an error occurring in a low-degree chip.

FIG. 8 is an example of a horizontal error correction algorithm.

FIG. 9 is an example of horizontal error detection using a syndrome shift.

FIG. 10 is an example of an SHE occurring in a low-degree chip.

FIG. 11 is an example of a DHE occurring in a low-degree chip.

FIG. 12 is a flowchart of a row and column error control RL-ECC decoding method according to an embodiment of the present disclosure.

FIG. 13 is a flowchart of a horizontal error correction decoding based on an RS code.

FIG. 14 is an example of a horizontal error control RL-ECC.

FIG. 15 is an example of an error pattern calculation through reverse shifting.

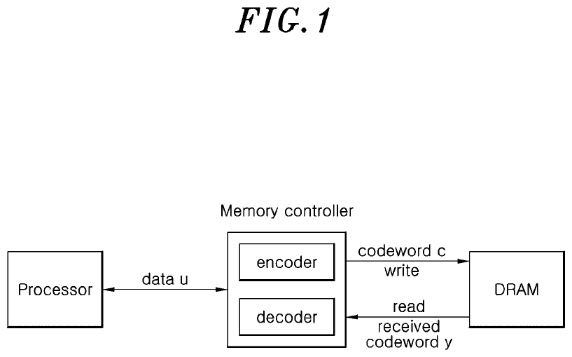

### DETAILED DESCRIPTION

The advantages and features of the present disclosure and the methods for achieving them will become clear by reference to the embodiments described below in detail in conjunction with the accompanying drawings. However, the present disclosure is not limited to the embodiments disclosed below, but may be implemented in various different forms. These embodiments are provided only to complete the disclosure of the present disclosure and to fully inform a person of ordinary skill in the art to which the present disclosure pertains of the scope of the disclosure, and the present disclosure is only defined by the scope of the claims.

Terms used in this specification will be briefly described, and the present disclosure will be described in detail.

The terms used in the present disclosure have been selected from generally widely used current terms, if possible, in consideration of the functions in the present disclosure, but this may vary depending on the intention of a person skilled in the art, precedent, or the emergence of new technology. Furthermore, in specific cases, there are terms arbitrarily selected by the applicant, and in this case, the meaning will be described in detail in the description of the corresponding disclosure. Therefore, the terms used in the present disclosure should be defined based on the meaning of the terms and the overall content of the present disclosure, not simply the names of the terms.

Throughout the specification, when a part “comprises” a component, it means including other components rather than excluding other components unless there is a specific statement to the contrary.

Furthermore, the term “unit” as used in the specification refers to a software or hardware component such as an FPGA or ASIC, and the “unit” performs certain roles. However, “unit” is not limited to software or hardware. A “unit” may be in an addressable storage medium and may be executed by one or more processors. Thus, as an example, a “unit” includes components such as software components, object-oriented software components, class components, and task components, and processes, functions, attributes, procedures, subroutines, segments of program code, drivers, firmware, microcode, circuits, data, databases, data structures, tables, arrays, and variables. The functions provided in the components and “units” may be combined into a smaller number of components and “units” or further separated into additional components and “units”.

Hereinafter, embodiments of the present disclosure will be described in detail with reference to the accompanying drawings so that a person of ordinary skill in the art to which the present disclosure pertains may easily carry out the embodiments. And in the drawings, parts unrelated to the description are omitted to clearly describe the present disclosure.

Semiconductor memory ECC uses RL-ECC, which corrects errors on a rank-by-rank basis, with each rank composed of multiple DRAM chips. The present disclosure deals with RL-ECC using RS codes among semiconductor memory ECCs.

In the following description, a vector is also equivalently expressed as a polynomial having the elements of the vector as coefficients. For example, a z=[zₙ₋₁, zₙ₋₂, . . . , z₀] of length n is also expressed as a polynomial z(x)=zₙ₋₁xⁿ⁻¹+zₙ₋₂xⁿ⁻²+ . . . +z₀. Conversely, expressing a polynomial as a vector is also possible through the same method. Furthermore, polynomial expressions and vector expressions are used interchangeably. For vector expressions, reverse indexing is considered for convenience, but without loss of generality.

The RS code is a type of non-binary cyclic code which corrects errors on a symbol-by-symbol basis by grouping multiple bits into one symbol. An RS code designed based on a finite field GF(2^{m})={0, 1, α,α², . . . , α^{2m-2}} has a length of n=2^{m}−1, and each symbol becomes an element of GF(2^{m}) which may be expressed by m bits. Here, a is a primitive element of GF(2^{m}). An RS code may be generated to have a t-symbol error correction capability, and in this case, the number of parity symbols is p=2t. The length of the data k becomes k=n−2t, which excludes the parity from the codeword, and this is also called the dimension of the code. For example, a 4-symbol error correction RS code using 8-bit symbols (symbols composed of 8 bits) is designed as an (n,k)=255,247 RS code.

The RS code performs polynomial-based encoding. This proceeds by appending n-k parities r=[rₙ₋ₖ₋₁, rₙ₋ₖ₋₂, . . . , r₀] to a message u=[uₖ₋₁, uₖ₋₂, . . . , u₀] to generate a codeword c=[cₙ₋₁, cₙ₋₂, . . . , c₀]=[uₖ₋₁, uₖ₋₂, . . . , u₀, rₙ₋ₖ₋₁, . . . , r₀] of length n. At this time, the parity r corresponds to the vector representation of r(x), where r(x) is the remainder and q(x) is the quotient when the polynomial representation of the message u(x) multiplied by x^{n-k} is divided by the generator polynomial g(x). For an RS code to correct t errors, the generator polynomial g(x) may be formed as a 2t-degree polynomial having α,α², . . . α^{2t} as roots, and this case is called a primitive RS code. This may be expressed as Equation 1 below. Here, since a characteristic 2 finite field operation is assumed, subtraction is the same as addition.

$$g ( x ) = ( x + α ) ( x + {α}^{2} ) ⋯ ( x + {α}^{2 t} ) \qquad Equation 1$$

$$u ( x ) \cdot {x}^{n - k} = g ( x ) \cdot q ( x ) + r ( x )$$

$$\begin{matrix}c ( x ) = u ( x ) \cdot {x}^{n - k} + r ( x ) \\ = g ( x ) \cdot q ( x ) + r ( x ) + r ( x ) \\ = g ( x ) \cdot q ( x )\end{matrix}$$

Therefore, the codeword c(x) has the generator polynomial g(x) as a factor and is divisible by g(x). This is an important property used when confirming which an error pattern may be obtained via a syndrome in RS decoding. The received codeword y(x) may include an error e(x) as mentioned before, and the purpose of the decoder is to receive y(x) as input and restore c(x). The decoding of an RS code is performed based on a syndrome, and this syndrome is calculated from the received codeword y(x) and includes information about the error e(x). In a cyclic code, a syndrome may be defined in two ways.

First, there is a method of calculating a syndrome S=[S₁, S₂, . . . , S₂ₜ] by substituting the roots of the generator polynomial g(x) into y(x). Here, y(x) is c(x) with e(x) added, and since c(x) has g(x) as a factor, when the roots of g(x) are substituted into y(x), the value of c(x) becomes 0, and only the value of e(x) with the roots of g(x) substituted remains. This may be expressed as Equation 2 below.

$$S = [ \begin{matrix}{S}_{1} & {S}_{2} & ⋯ & {S}_{2 t} ]\end{matrix} \qquad Equation 2$$

$${S}_{i} = y ( {α}^{i} ) , 1 \leq i \leq 2 t$$

$$\begin{matrix}y ( {α}^{i} ) = c ( {α}^{i} ) + e ( {α}^{i} ) \\ = g ( {α}^{i} ) \cdot q ( {α}^{i} ) + e ( {α}^{i} ) \\ = e ( {α}^{i} )\end{matrix}$$

Therefore, the syndrome S is determined solely by the error e(x), regardless of the codeword c(x).

Alternatively, a syndrome may be defined as a polynomial. The syndrome s(x) may be defined as the remainder of the received codeword y(x) divided by the generator polynomial g(x), i.e., y(x) mod g(x), which will henceforth be referred to as the polynomial syndrome. The polynomial expression S(x) of the previously obtained syndrome S and the polynomial syndrome s(x) refer to different syndromes, and they are distinguished by letter case. The polynomial syndrome s(x) is also determined solely by the error e(x), because the codeword c(x) has the generator polynomial g(x) as a factor. This may be expressed as Equation 3 below.

$$\begin{matrix}s ( x ) = y ( x ) mod g ( x ) \\ = \{ c ( x ) + e ( x ) \} mod g ( x ) \\ = \{ g ( x ) \cdot q ( x ) + e ( x ) \} mod g ( x ) \\ = e ( x ) mod g ( x ) \\ = {s}_{2 t - 1} {x}^{2 t - 1} + ⋯ + {s}_{0}\end{matrix} \qquad Equation 3$$

According to the Chinese Remainder Theorem, the two syndromes S and s(x) have a one-to-one correspondence and are mutually convertible. Whichever syndrome is used, since the syndrome is determined solely by the error, the error may be obtained and corrected based on the syndrome. However, since the number of types of total errors is greater than the number of syndromes, the syndromes of errors are bound to overlap. Therefore, not all errors are correctable, and for syndrome-based error correction to be possible, there generally should be no overlap between the syndromes of the target errors to be corrected.

Looking at the process of syndrome-based error correction, first, a syndrome is calculated from a received codeword, and an error pattern expected to have occurred is derived through the syndrome value. Then, error correction is completed by subtracting the expected error pattern from the received codeword. The general decoding of an RS code proceeds based on the syndrome S and its polynomial expression S(x), and the process is largely composed of three stages: determination of an error locator polynomial, determination of error locations, and determination of error values. In the stage of determining the error locator polynomial, an error locator polynomial, which is a polynomial having roots which represent information about error locations, is obtained by using the BM (Berlekamp-Massey) or ME (modified Euclidean) algorithm. Next, in the stage of determining error locations, the roots of the error locator polynomial are found through Chien's search, and the locations where errors occurred are calculated. Finally, in the stage of determining error values, when the locations where errors occurred are known, an error pattern may be obtained by calculating the error value corresponding to the error location using the Forney algorithm. By subtracting the expected error pattern ê(x) thus obtained from the received codeword y(x), an error-corrected codeword ĉ(x) is obtained, and an error-corrected message û(x) may be obtained by excluding a parity portion from ĉ(x).

When correcting errors on a symbol-by-symbol basis, even if errors occur in several of the m bits constituting one symbol, it is classified as a single symbol error, which is advantageous for correcting multi-bit errors in an environment where errors may be locally concentrated. This advantage of symbol-level error correction is one of the reasons why RS codes were adopted for RL-ECC in DRAM memory. This is because it is capable of effectively responding to cases where locally concentrated errors occur due to defects in the DRAM chip from manufacturing defects, aging of parts, and so on.

There may be various types of RL-ECC using RS codes depending on the method of determining the bits constituting a symbol and the number of bits. Among them, Bamboo ECC is a technique which applies RS codes by grouping multiple bits in the vertical direction from a single pin into one symbol, and it has shown more effective error correction capability against vertical errors due to DRAM pin defects compared to previous RL-ECCs which formed symbols horizontally. If a defect exists in a pin of a DRAM chip, errors may occur with a high probability in the bits read from that pin. At this time, a horizontal symbol formation has a low probability of correction because these errors exist across multiple symbols, but a vertical symbol formation has a high probability of being correctable because these errors exist in a single symbol.

This symbol formation, especially when forming a rank using ×4 chips, enables chipkill correction through 8 parity pins, showing excellent responsiveness to horizontal errors as well. However, when using an ×8 DRAM chip, since it corrects errors occurring in up to 4 pins with 8 parity pins, there is a problem of being vulnerable to horizontal errors such as DQS errors compared to horizontal symbol formation.

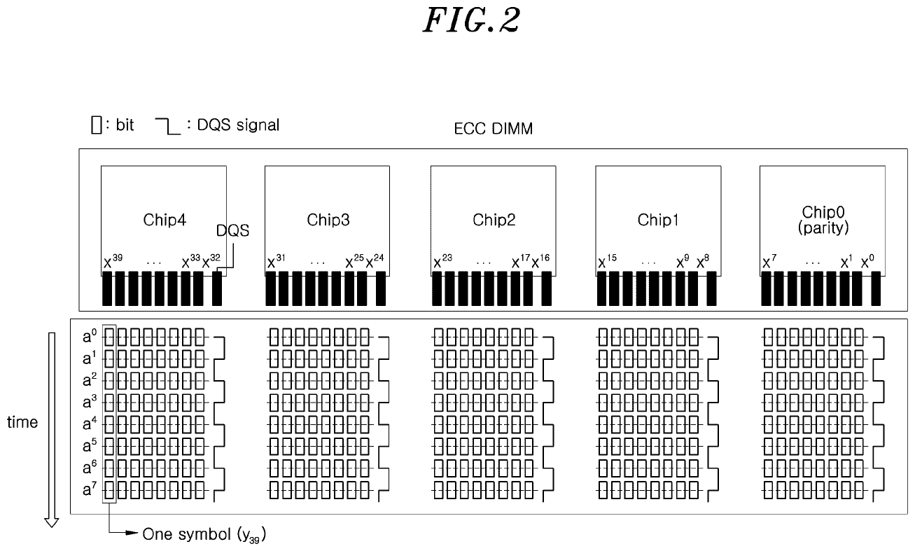

As an example of RL-ECC using Bamboo ECC, Bamboo ECC may be applied to a DDR5 DIMM which uses 5×8 DRAM chips, with 4 as data chips and 1 as a parity chip. FIG. 2 is a diagram illustrating this, where the 8 bits highlighted with a black background form one symbol, and this symbol represents c₃₉ of the RS codeword c(x). For example, if the c₃₉ symbol value is α²¹¹, this symbol may be expressed as a sum of several symbols according to the primitive polynomial of GF(2⁸). If the primitive polynomial is α⁸+α⁴+α³+α²+1=0, then α²¹¹=α¹+α⁴+α⁵+⁷ is expressed, and this is stored in the DRAM as a binary sequence 0 1 0 0 1 1 0 1.

Conversely, when reading data stored in the DRAM, if the 8-bit sequence read from one pin was 0 1 0 0 1 1 0 1, this symbol becomes α¹+α⁴+α⁵+α⁷=α²¹¹. In this way, the bit sequences from 0 0 0 0 0 0 0 0 to 1 1 1 1 1 1 1 1 become GF(2⁸) symbol values from 0 to α²⁵⁴.

By designing an RS code with 8 parity symbols using 8-bit symbols, a 255,247 4-symbol error correction RS code may be designed. However, since there are actually 40 pins, the number of symbols and the length of the RS code do not match, which may be addressed by using a shortened code.

Here, shortening involves encoding by fixing 215 of the 247 message symbols to 0, and not actually transmitting them. The number of actually transmitted message symbols is 32, but the encoder and decoder proceed with encoding/decoding with a length of 255,247, including the fixed 0s. By doing so, a codeword may be protected from symbol errors using a 40,32) shortened RS code. A shortened RS code may maintain the original error correction capability before shortening, so a 40,32 shortened RS code may still correct 4 symbol errors. The Bamboo ECC used in the present disclosure fixes c₂₅₄~c₄₀ of the codeword polynomial c(x) to 0 and uses the symbols read and written from each pin as c₃₉~c₀.

There are many types of errors which may occur in a DRAM chip. Among them, errors caused by defects in the chip may be a major problem for reliability because they occur continuously until the defect is found. Even if a defect occurs in one pin and errors continuously occur in the bits coming from that pin, Bamboo-ECC using the vertical symbol formation of the RS code may correct a majority of vertical symbol errors. However, in the case of a horizontal error where a defect occurs in the chip and errors occur simultaneously on multiple pins even once while reading the m bits constituting a symbol, this error may fall outside the error correction range of the RS code.

A DQS error is an example of a horizontal error. The moment of reading data from a DRAM chip is determined by the DQS signal. If an abnormality occurs in this DQS signal, causing a timing error at the point of reading data, errors may occur in all symbols spanning that chip. When considering an RL-ECC which corrects t symbol errors using one chip with 2t pins as a parity chip, up to 2t symbol errors may occur due to a DQS error, which exceeds the basic error correction capability of the applied RS code.

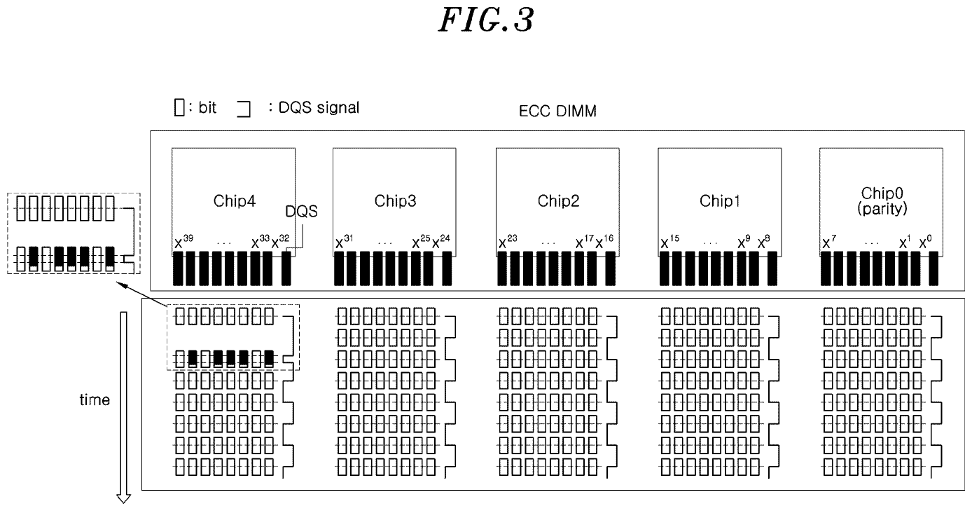

FIG. 3 is a diagram expressing an example where a horizontal error occurred in the second row of Chip0 when t=4. FIG. 3 shows a case where the moment of reading the second bit is delayed due to a DQS signal abnormality, causing some pins to read the third bit value twice. In this example, the horizontal error pattern is e(x)=αx³⁸+αx³⁶+αx³⁵+αx³⁴+αx³². The RL-ECC using Bamboo ECC has 8 parity symbols, so it is capable of correcting up to 4 symbol errors, but since errors occurred in 5 symbols, it is not correctable.

As such, a vertical symbol formation like Bamboo ECC may not correct all errors occurring in a single chip when only one parity chip (e.g., 8 symbols) is used. In particular, the occurrence of a horizontal error may affect all symbols read from the corresponding chip, so there is a high probability of causing an uncorrectable error with an RS code using a vertical symbol formation. Therefore, the development of a technique to respond to horizontal errors using a vertical symbol formation RS code is necessary.

There is one problem in the development of such a technique. Since an RS code performs error correction based on a syndrome, if there is no overlap between the syndrome values of the error patterns to be corrected, correction is possible, but there is a problem with the practical implementation of the decoding method. To obtain an error pattern, a syndrome-error pattern mapping table, which obtains a horizontal error pattern using the syndrome as a key, may be used, but there is difficulty in implementing this mapping table. In the case of a 40,32 shortened RS code, compared to the total number of syndromes which may be obtained from a received codeword (2^{m(n-k)}−1), the number of syndromes to be detected, i.e., the number of syndromes for the target errors, is 3,720 for SHE (single horizontal error), which represents a case where a horizontal error occurs once within one chip during m reads of the bits constituting a symbol, and 8,104,740 for DHE (double horizontal error), which means it occurred twice. To correct errors using these syndromes, a filter is needed to match the detected syndrome to its corresponding error pattern, but the problem is that its scale is too large.

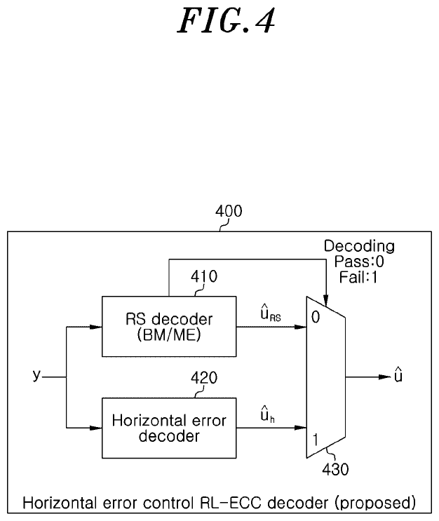

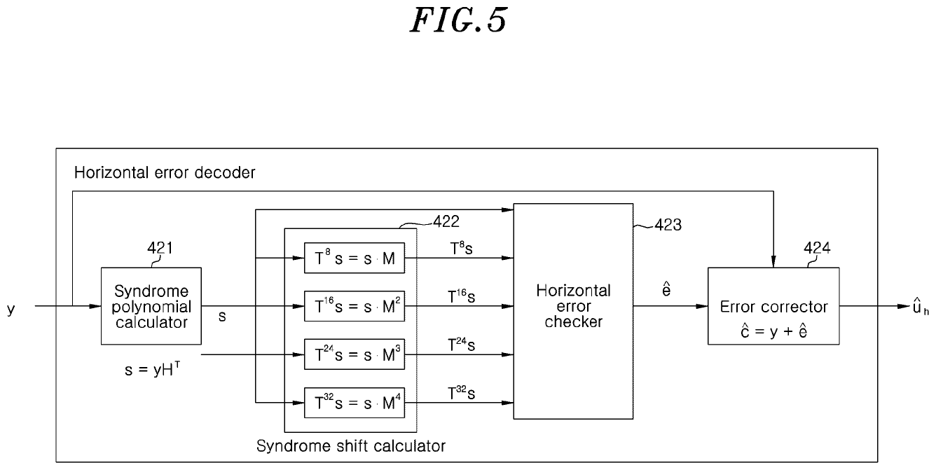

FIG. 4 is a block diagram of a row and column error control RL-ECC decoding apparatus according to an embodiment of the present disclosure, and FIG. 5 is a detailed block diagram of the horizontal error correction decoder shown in FIG. 4.

Referring to FIG. 4 and FIG. 5, a row and column error control RL-ECC decoding apparatus 400 according to an embodiment includes an RS decoder 410, a horizontal error decoder 420, and a decoding output selector 430.

The RS decoder 410 receives a codeword as input and corrects a vertical error of t symbols or less of the RS code.

The horizontal error decoder 420 receives the codeword as input and corrects a horizontal error of t+1 symbols or more.

The decoding output selector 430 selects one of the output of the RS decoder 410 and the output of the horizontal error decoder 420 to output a decoding result. Here, the decoding output selector 430 selects the output of the RS decoder 410 if decoding is successful according to a decoding result signal of the RS decoder 410, and selects the output of the horizontal error decoder 420 if decoding fails according to the decoding result signal to output the decoding result, and when both the output of the RS decoder and the output of the horizontal error decoder exist, the decoding output selector 430 selects the output of the RS decoder 410 to output the decoding result.

The horizontal error decoder 420 may include a polynomial syndrome calculator 421, a syndrome shift calculator 422, a horizontal error detector 423, and an error corrector 424.

The polynomial syndrome calculator 421 calculates a polynomial syndrome for the received codeword. For example, the polynomial syndrome calculator 421 may receive a codeword vector y as an input, performs a matrix multiplication of y and the transpose matrix H^{T} of the PCM H to calculate a syndrome vector s, and provide it to the syndrome shift calculator 422 and the horizontal error detector 423.

The syndrome shift calculator 422 calculates the syndrome of a cyclically shifted error pattern (hereinafter referred to as shift syndrome) for the polynomial syndrome calculated by the polynomial syndrome calculator 421. For example, the syndrome shift calculator 422 obtains the shift syndrome by using a syndrome shift property for calculating the polynomial syndrome corresponding to an error pattern which has undergone a cyclic shift through the polynomial syndrome for an arbitrary error pattern.

The horizontal error detector 423 detects and derives a horizontal error for the syndrome of the error pattern calculated by the syndrome shift calculator 422. For example, the horizontal error detector 423 performs a conditional check, which will be described later, on the shift syndrome calculated by the shift calculator 422 by using the polynomial syndrome-error pattern matching property in a chip corresponding to the lowest degree. Through this, the horizontal error detector 423 determines whether a horizontal error has occurred, and if it is determined that a horizontal error has occurred, an error pattern may be derived by detecting the horizontal error from the shift syndrome cyclically shifted to the lowest-degree chip and then placing it in its original position by a reverse cyclic shift. Here, a ‘chip’ refers to a space where coefficients of consecutive degrees of a polynomial codeword are stored in groups, and the ‘lowest-degree chip’ refers to the storage space among these where the coefficient group of the lowest degree of the polynomial codeword is stored, while ‘polynomial codeword’ means a codeword expressed in polynomial form. The content of the conditional check performed by the horizontal error detector 423 is as follows: the horizontal error detector 423 observes the symbol values of the shift syndrome vector, stores the number of non-zero distinct symbol values, and determines that the syndrome does not correspond to an SHE (single horizontal error) or a DHE (double horizontal error) if the number is 4 or more, determines that it corresponds to an SHE or a DHE if the number is 2 or less, and if the number is 3, determines that it corresponds to a DHE if the condition that the sum of the first and second stored symbol values matches the third symbol value is satisfied, but determines that it does not correspond to a DHE if the condition is not satisfied. Here, ‘symbol value’ refers to the value of an individual GF(2^{m}) symbol constituting the syndrome vector of the RS code, and the number of distinct values is defined as the ‘number of types’.

The error corrector 424 corrects the horizontal error detected and derived by the horizontal error detector 423. For example, if there is no syndrome which satisfies the condition for each syndrome, the error corrector 424 may determine that no horizontal error has occurred and return the received codeword as it is.

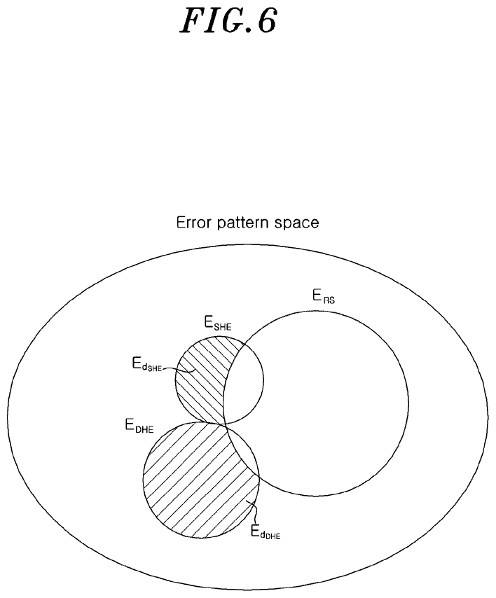

The row and column error control RL-ECC decoding apparatus 400 has a structure where the RS decoder 410, which corrects t symbols or less of a vertical error of an RS code as in FIG. 6, and the horizontal error decoder 420 for horizontal error correction operate in parallel. Both decoders 410, 420 receive the codeword y as input and output an error-corrected message as their respective outputs. That is, if an error of t symbols or less occurs, it is correctable by the RS decoder 410, and if an SHE or DHE error of t+1 symbols or more occurs, it is correctable by the horizontal error decoder 420.

In the selection of the output of the two decoders 410, 420, the decoding result of the RS decoder 410 has priority. Depending on the decoding result signal of the RS decoder 410, if the decoding is successful, the output of the RS decoder 410 is selected, and if the decoding fails, the output of the horizontal error decoder 420 is selected to obtain the final decoding result û. If both decoders 410, 420 fail to decode, the original received codeword y is output. For example, if a codeword including a t+1 symbol SHE error is received, this received codeword is transmitted to the RS decoder 410 and the horizontal error decoder 420, respectively, and decoding proceeds. As a result, the RS decoder 410 transmits a signal indicating that decoding has failed, and the horizontal error decoder 420 delivers a codeword [symbol] with the SHE error removed, so [symbol] is selected as the final output û.

The RS code, which is a linear block code, performs symbol-level error correction based on a syndrome. To determine an error pattern through a syndrome, a syndrome calculated from a received codeword and the error pattern corresponding to that syndrome needs to be mapped one-to-one, and therefore, there should not be a case where the same syndrome is calculated for different error patterns corresponding to the correction target.

The number of all available syndromes for a 255,247 RS code is (2⁶⁴−1)≅1.84×10¹⁹, since there are 8 parity symbols and each symbol may have 2⁸ values, excluding 0. The number of error patterns targeted for 4-symbol error correction of the RS code is Σ⁴ᵢ₌₁(ᵢ²⁵⁵)(2⁸−1)ⁱ≅7.28×10¹⁷, and the number of available syndromes is about 25 times larger.

This syndrome margin is deepened by shortening, because as some symbols are fixed to 0, the number of symbols where errors may occur decreases, thus reducing the number of target error patterns for correction, while the total number of syndromes remains the same. In a 40,32 shortened RS code, the number of error patterns targeted for 4-symbol error correction is Σ⁴ᵢ₌₁(ᵢ⁴⁰)(2⁸−1)ⁱ≅3.87×10¹⁴. Due to shortening, the syndrome margin is deepened, and the number of available syndromes is about 47,500 times larger. Due to the syndrome margin deepened by shortening, syndrome overlap of the correction error pattern set may not occur, and even if it does, the ratio may be very small.

For the validity of the present disclosure, whether syndrome overlap of the target error patterns occurs was confirmed. Let the correction target error pattern set of the RS code (the set of error patterns of t symbols or less) be E_{RS}, the SHE error pattern set where a horizontal error occurs once in one chip be E_{SHE}, and the DHE error pattern set where a horizontal error occurs twice in one chip be E_{DHE}. The error pattern sets to be additionally corrected are the union E_{d}=E_{dSHE}∩E_{dDHE} (the shaded part in FIG. 6) of the SHE error pattern set (t+1 symbols or more SHE error pattern set) E_{dSHE}=E_{SHE}−E_{RS} and the t+1 symbols or more DUE error pattern set E_{dSHE}=E_{SHE}−E_{RS}, which are elements of the E_{SHE} and E_{DHE} sets which exceed the t-symbol error correction capability of the existing RS code. To additionally correct the E_{dSHE} set and the E_{dDHE} set while maintaining the existing E_{RS} set correction based on the syndrome, there should be no syndrome overlap for S_{RS} and S_{d}, which are the sets of syndromes corresponding to the elements of the error pattern sets, i.e., S_{RS}∩S_{dSHE}=φ, S_{RS}∩S_{dDHE}=φ, S_{dSHE}∩S_{dDHE}=φ.

Whether syndrome overlap of the correction error pattern set occurs may change depending on the length and dimension of the RS code. As a result of an experiment on a 40,32 shortened RS code in consideration of its use in a DDR5 environment, it was confirmed that all elements of E_{dSHE} are correctable, and about 99.999% of the 8,104,740 elements of E_{dDHE}, except for 79, are correctable without miscorrection due to syndrome overlap.

However, even if syndrome overlap is avoided, a problem with the implementation method of the decoder exists. To correct a horizontal error through a syndrome, when the decoder receives a syndrome, the decoder determines whether it is a syndrome corresponding to a horizontal error, and if it is, the syndrome is mapped to the appropriate error pattern. However, the number of DUE error patterns to be corrected is 8,104,740, and there are difficulties in implementing this using a simple mapping table without implementation through an algorithm. Therefore, in the present disclosure, a systematic implementation method using an algorithm is used, not an implementation using a mapping table.

The present disclosure has the same RS code design as the prior art for data encoding because it only changes the decoder structure for additional correction of horizontal errors. The row and column error correction RL-ECC technique of the present disclosure is applicable to all cases where one chip with 2t parity bits is used for RL-ECC, but for the sake of explanation, the case where t=4 is described as an example. When t=4, one symbol is composed of 8 bits, and the symbols are stored and read through one pin each over 8 times. A 4-symbol error correction RS codeword designed in GF(2⁸) has a length of 255 symbols, and this is shortened to a length of 40 for use. The i-th chip (chip i) stores and transmits the coefficients x⁸ⁱ~x⁸ⁱ⁺⁷⁰f c₈ᵢ~c₈ᵢ₊₇.

Before describing the horizontal error correction method in detail, the polynomial syndrome used in the present disclosure will be described first. The horizontal error decoder 420 also performs error correction based on the syndrome value by calculating the syndrome from the received codeword, same as the existing RS code decoder. The syndrome of the horizontal error decoder 420 is calculated differently from the syndrome of the existing RS code decoding, and will henceforth be called the polynomial syndrome s(x), which is a polynomial distinct from the polynomial expression S(x) of the syndrome S used in the BM or ME algorithm.

The syndrome S=[S₁, S₂, . . . , S₈] used in the existing RS code is a vector whose elements are Sᵢ=y(αⁱ) obtained by substituting the roots αⁱ, where 1≤i≤8 of the generator polynomial g(x) into the received codeword, and this value corresponds to the remainder when the received codeword is divided by (x+αⁱ). On the other hand, the syndrome s(x) of the horizontal error decoder is the remainder when the received codeword is divided by the generator polynomial (x+α)(x+α¹) . . . (x+α⁸). Although the calculation methods of these two syndromes are different, it may be shown that they are equivalent through the Chinese Remainder Theorem.

For horizontal error correction, a syndrome polynomial is first calculated from the received codeword. A received codeword vector y of length n may be obtained by reading the data stored in the DRAM, and if this is represented in vector form y and polynomial form y(x), they may be respectively expressed as in Equation 4 below.

$$y = [ \begin{matrix}{y}_{39} & {y}_{38} & ⋯ & {y}_{0}\end{matrix} ] , where {y}_{i} ∈ GF ( {2}^{8} ) \qquad Equation 4$$

$$y ( x ) = {y}_{39} {x}^{39} + {y}_{38} {x}^{38} + ⋯ + {y}_{0} , where {y}_{i} ∈ GF ( {2}^{8} )$$

The syndrome polynomial s(x) may be obtained as the remainder of the received codeword polynomial y(x) divided by the generator polynomial g(x) of the RS code. The received codeword polynomial y(x) is an expression in which the error pattern polynomial e(x) is added to the codeword polynomial c(x), and since the codeword polynomial c(x) has the generator polynomial g(x) as a factor according to the design of the RS code, the syndrome polynomial s(x) is determined solely by the error pattern, and since the generator polynomial is an 8th-degree polynomial, the syndrome polynomial has a degree of 7 or less. This is expressed by a formula as in Equation 5 below.

$$\begin{matrix}s ( x ) = y ( x ) mod g ( x ) \\ = {s}_{7} {x}^{7} + {s}_{6} {x}^{6} + ⋯ + {s}_{1} x + {s}_{0} , {s}_{i} ∈ GF ( {2}^{8} )\end{matrix} \qquad Equation 5$$

In FIG. 5, the syndrome polynomial calculator 421 is a part which calculates the syndrome polynomial s(x) from the received codeword y(x), and the calculation consists of s(x)=y(x) mod g(x)=s₀+s₁x+ . . . +s₇x⁷. This operation may be simplified to a matrix multiplication operation with the transpose matrix H^{T} of the parity check matrix (PCM) H of the RS code to reduce the complexity of the remainder operation for the 8th-degree polynomial g(x). This is because the parity check matrix H of the RS code used here is a matrix whose columns are the coefficients of the respective remainders of x³⁹~x⁰ divided by g(x). If the remainder of xⁱ divided by g(x) is rᵢ(x)=rᵢ₇x⁷+rᵢ₆x⁶+ . . . rᵢ₀, then the remainder of y(x) divided by g(x) may be written as in Equation 6 below.

$$\begin{matrix}y ( x ) mod g ( x ) = {y}_{39} {x}^{39} + {y}_{38} {x}^{38} + ⋯ + {y}_{0} mod g ( x ) \\ = {y}_{39} ( {x}^{39} mod g ( x ) ) + \\ {y}_{38} ( {x}^{38} mod g ( x ) ) + ⋯ + {y}_{0} ( 1 mod g ( x ) ) \\ = {y}_{39} ( {r}_{{39}_{7}} {x}^{7} ) + {y}_{39} ( {r}_{{39}_{6}} {x}^{6} ) + ⋯ + {y}_{39} ( {r}_{{39}_{0}} ) + \\ {y}_{38} ( {r}_{{38}_{7}} {x}^{7} ) + {y}_{38} ( {r}_{{38}_{6}} {x}^{6} ) + ⋯ + {y}_{38} ( {r}_{{38}_{0}} ) + \\ ⋮ \\ {y}_{0} ( {r}_{{0}_{7}} {x}^{7} ) + {y}_{0} ( {r}_{{0}_{6}} {x}^{6} ) + ⋯ + {y}_{0} ( {r}_{{0}_{0}} )\end{matrix} \qquad Equation 6$$

Therefore, this equation may be expressed as the product of y=[y₃₉, y₃₈, . . . , y₀] and H^{T} as in Equation 7.

$$s = [ \begin{matrix}{s}_{7} & {s}_{6} & {s}_{5} & {s}_{4} & {s}_{3} & {s}_{2} & {s}_{1} & {s}_{0}\end{matrix} ] = {yH}^{T} \qquad Equation 7$$

That is, the syndrome polynomial calculator 421 receives the codeword vector y as input, performs a matrix multiplication of y and the transpose matrix H^{T} of the PCM H to calculate the syndrome vector s, and delivers the calculation result to the syndrome shift calculator 422 and the horizontal error detector 423.

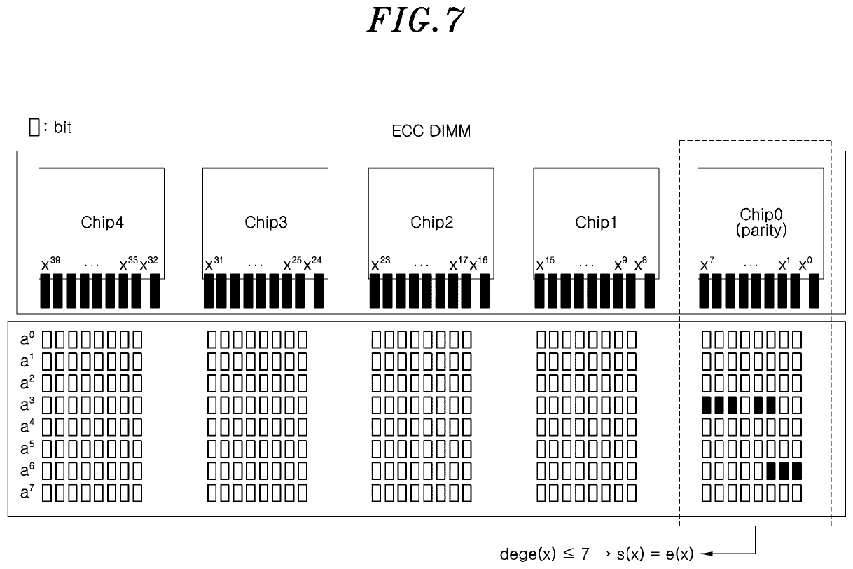

The polynomial syndrome-error pattern matching property in a low-degree chip, i.e., the lowest-degree chip, will be examined. First, a method for correcting a horizontal error occurring in a chip corresponding to a low degree of a polynomial codeword (hereinafter, a low-degree chip, Chip0 in FIG. 7) will be described, and then a method for deriving and correcting an error pattern by moving a horizontal error occurring in the remaining chips to the low-degree chip using the cyclic property of the RS code to detect the horizontal error, and then placing it in its original position by a reverse shift will be described.

In the present disclosure, the polynomial syndrome-error pattern matching property in a low-degree chip is used for the systematic detection and derivation of horizontal errors. As shown in Equation 8, this refers to the property that if an error occurs only in a low-degree chip of x, so the degree of the error pattern polynomial e(x) is 7 or less, the remainder of this divided by the generator polynomial g(x) becomes itself according to the polynomial modulo operation, so the error pattern polynomial becomes the syndrome polynomial.

$$deg e ( x ) \leq 7 \to s ( x ) = e ( x ) mod g ( x ) = e ( x ) \qquad Equation 8$$

Therefore, a single-chip horizontal error pattern may be directly obtained through the polynomial syndrome without a separate operation.

Furthermore, this property is also useful for detecting horizontal errors. When detecting whether a certain syndrome corresponds to a single-chip horizontal error, since a horizontal error in a low-degree chip has a syndrome which also has the characteristics of a horizontal error, it is possible to attempt to detect the syndrome of that error pattern by using the characteristics of a single-chip horizontal error pattern (DHE, SHE).

In the case of horizontal errors occurring in chip locations other than the low-degree chip, the polynomial syndrome-error pattern matching property does not hold, causing a problem in the detection and derivation of the error pattern. To solve this, the syndrome shift property of the polynomial syndrome is used. The syndrome shift property means that the polynomial syndrome (shift syndrome) corresponding to an error pattern e(x)·xⁱ, which is a cyclically shifted version of an arbitrary error pattern e(x), may be calculated through the polynomial syndrome s(x) of that error pattern.

For example, if the polynomial syndrome for a certain error pattern e(x) is s(x), the polynomial syndrome of the error pattern x·e(x), which is cyclically shifted by 1, is calculated as x·e(x) mod g(x), which may also be calculated as x·s(x) mod g(x). This is equally applicable to an error pattern cyclically shifted by an arbitrary number i, and may be proven as in Equation 9 below.

$$\begin{matrix}e ( x ) \cdot {x}^{i} mod g ( x ) = [ \{ e ( x ) mod g ( x ) \} \cdot \{ {x}^{i} mod g ( x ) \} ] mod g ( x ) \\ = [ s ( x ) \cdot \{ {x}^{i} mod g ( x ) \} ] mod g ( x ) \vert \\ = [ \{ s ( x ) mod g ( x ) \} \cdot \{ {x}^{i} mod g ( x ) \} ] mod g ( x ) \\ = s ( x ) \cdot {x}^{i} mod g ( x )\end{matrix} \qquad Equation 9$$

Using this, the syndrome when the same error occurs in a low-degree chip may be calculated through the syndrome of a horizontal error which occurred in an arbitrary chip. Since horizontal errors occur on a chip-by-chip basis, the corresponding shift syndromes are obtained by cyclically shifting the error pattern in units of x⁸. That is, the syndrome of e(x)x^{-8h} is calculated by multiplying e(x) by x^{-8h}, where 1≤h≤4, which may be calculated as in Equation 10 below.

$$e ( x ) \cdot {x}^{- 8 h} mod g ( x ) = s ( x ) \cdot {x}^{- 8 h} mod g ( x ) \qquad Equation 10$$

If there exists one among the syndromes of x^{-8h}e(x) thus obtained which satisfies the condition of a horizontal error to be described later, the original error pattern e(x) may be obtained by shifting that error pattern back by x^{8h}. The reason why 1≤h≤4 is because it is not known how far the chip where the current horizontal error occurred is from the low-degree chip, so candidates are obtained for all possible cases.

An algorithm for systematically correcting horizontal errors using the two properties of the polynomial syndrome described above will be briefly explained, and then details such as the detection conditions for horizontal errors and the specific implementation of the decoder will be discussed later.

For horizontal error correction, a polynomial syndrome s(x) is first calculated from a received codeword y(x). Then, after obtaining shift syndromes T^{8h}s(x), 1≤h≤4 using the syndrome shift property of the polynomial syndrome, it is confirmed whether the original polynomial syndrome s(x) and the four shift syndromes, a total of five candidate syndromes, satisfy the horizontal error condition which occurred in the lowest-degree chip.

If a syndrome satisfying the condition exists, it means that that syndrome is identical to x^{-8h}e(x), so e(x) is obtained by shifting it back by the amount it was shifted, and this is used as to correct the error ê(x). If a syndrome satisfying the condition does not exist, it is determined that no horizontal error has occurred, is set to ê(x)=0, and the received codeword is returned as it is.

Algorithm 1 in FIG. 8 shows the horizontal error correction algorithm in pseudo-code, where E₀ is the set of error patterns which satisfy the conditions for horizontal errors. Here, lines 4 to 14 proceed sequentially using if and else if, but in the actual operation of the decoder, each if statement may be implemented in parallel and proceed simultaneously.

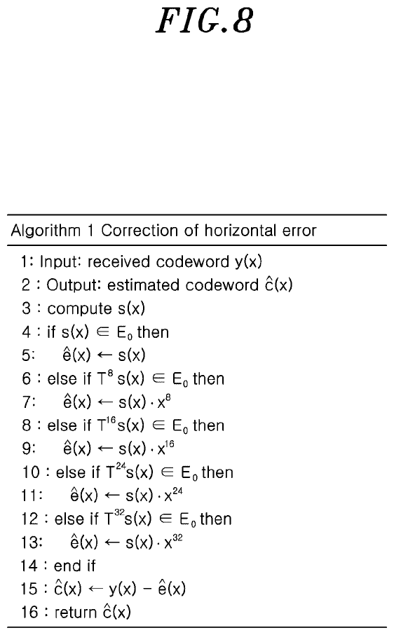

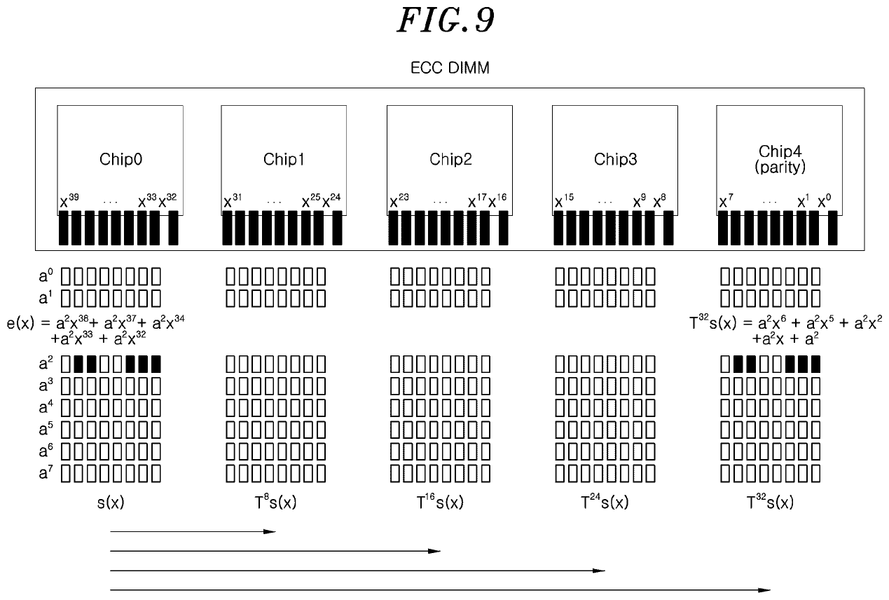

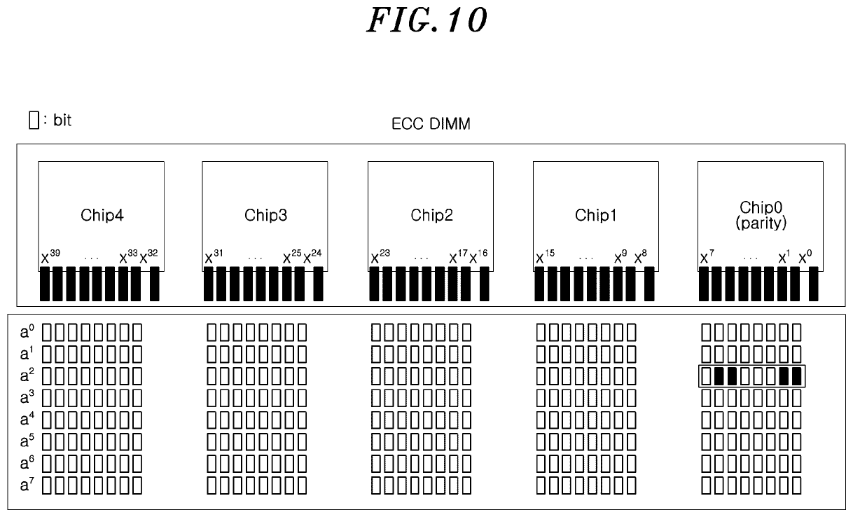

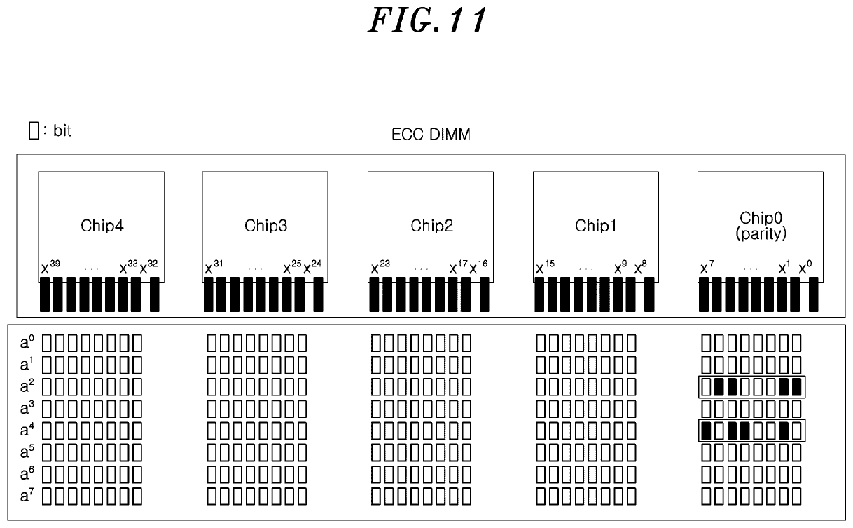

FIG. 9 is an example of horizontal error detection using a syndrome shift, FIG. 10 is an example of an SHE occurring in a low-degree chip, and FIG. 11 is an example of a DHE occurring in a low-degree chip.

Next, as a specific content of the decoding method, the condition for detecting a horizontal error which occurred in a low-degree chip will be described. First, the detection method for SHE will be described, followed by the detection method for DUE.

For an SHE which occurred in a low-degree chip, since the syndrome becomes the error pattern, if it is possible to know whether the syndrome corresponds to the syndrome of an SHE, the SHE may be corrected by using that syndrome as the error pattern. For SHE syndrome detection, the symbol value characteristics of the SHE pattern are used.

When an SHE occurs, the symbol corresponding to the pin where the error occurred has an error value corresponding to αⁱ, 0≤i≤7, and the remaining symbols have an error value of 0 since no error occurred. Furthermore, since an SHE occurs on a chip-by-chip basis, it occurs in units of x⁸. For example, when an SHE occurs in chip 0 as in FIG. 10, its error pattern polynomial may be expressed as in Equation 11 below.

$$e ( x ) = {α}^{2} {x}^{6} + {α}^{2} {x}^{5} + {α}^{2} {x}^{2} + {α}^{2} {x}^{1} + {α}^{2} \qquad Equation 11$$

The characteristic of the SHE pattern known here is that the non-zero symbol values of the error pattern are all identical. This is because the rows where the bit errors occurred are all the same.

That is, if, when a polynomial syndrome is calculated, the non-zero symbol values of that syndrome are all identical, this corresponds to the syndrome of an SHE which occurred in a low-degree chip, and at this time, since the error pattern is the syndrome itself, the error may be simply corrected.

The correction method for DHE is the same as for SHE, but one difference is the symbol value characteristics of SHE and DHE. As mentioned before, SHE has the characteristic which all non-zero symbol values are identical, and this point is used to detect the syndrome of an SHE. However, DUE may have more complex symbol values than SHE.

When a horizontal error occurs twice, the 8 pins may be divided into the following four cases: a pin where no bit error occurred in both instances, a pin where a bit error occurred only in the first horizontal error, a pin where a bit error occurred only in the second horizontal error, and finally, a pin where a bit error occurred in both instances. If the symbol value of the row where the first horizontal error occurred is αⁱ¹, and the symbol value of the row where the second horizontal error occurred is αⁱ², then the error pattern symbol values at each pin become 0, αⁱ¹, αⁱ², αⁱ¹+αⁱ².

For example, when a horizontal error occurs in the third (α²) row and the fifth (α⁴) row of chip 0 as in FIG. 11, the error pattern is e(x)=α⁴x³⁹+α²x³⁸+(α²+α⁴)x³⁷+α⁴x³⁶+(α²+α⁴)x³³+α²x³², and its symbol values have four types of values: 0,α2,α4,α2+α4. A DHE error pattern does not necessarily have four types of symbol values; it may have from one to four types of symbol values depending on the location of the pin where each horizontal error occurs.

The combination of these four types of symbol values is determined by the positions of the two rows where the horizontal errors occur. Therefore, from the combination for the case of the first and second rows (0,α⁰,α¹,α⁰+α¹) to the combination for the case of the seventh and eighth rows (0,α⁶,α⁷,α⁶+α⁷), there are (₂⁸)=28 combinations of four types of symbol values. That is, a DUE may have up to three types of non-zero symbol values, and if three types exist, it has the symbol value characteristic which one value is the sum of the other two values. This point is a distinguishing feature of the symbol values of a DUE pattern, different from the property of an SHE pattern which “all non-zero symbol values are identical”.

Next, a matrix multiplication-based implementation method of the horizontal error decoder 420 will be described. The syndrome shift calculator 422 in FIG. 5 is a part which receives a polynomial syndrome as input and calculates a shift syndrome T^{8h}s(x). The shift syndrome T^{8h}s(x) represents the polynomial syndrome of the error pattern e(x)x^{-8h} cyclically shifted by x^{8h}, T^{8h}s represents its vector expression, and is calculated as T^{8h}s(x)=e(x)x^{-8h} mod g(x)=s(x)x^{-8h} mod g(x). To calculate this, the remainder after multiplying s(x) by x^{-8h} and dividing by g(x) is calculated, and this operation may also be simplified to a matrix multiplication operation, similar to the calculation of the polynomial syndrome, to reduce the complexity of the operation.

If the remainder of xⁱ divided by g(x) is rᵢ(x)=rᵢ₇x⁷+rᵢ₆x⁶+ . . . +rᵢ₀, then the polynomial syndrome T¹s(x) of the error pattern cyclically shifted once may be calculated as in Equation 12 below.

$$\begin{matrix}{T}_{s}^{1} ( x ) & = s ( x ) {x}^{- 1} mod g ( x ) \\ & = ( {s}_{7} {x}^{6} + {s}_{6} {x}^{5} + ⋯ + {s}_{1} + {s}_{0} {x}^{- 1} ) mod g ( x ) \\ & = {s}_{7} ( {x}^{6} mod g ( x ) ) + {s}_{6} ( {x}^{5} mod g ( x ) ) + ⋯ + {s}_{0} ( {x}^{- 1} ) mod g ( x ) ) \\ & = {s}_{7} ( {x}^{6} mod g ( x ) ) + {s}_{6} ( {x}^{5} mod g ( x ) ) + ⋯ + {s}_{0} ( {x}^{254} ) mod g ( x ) ) \\ & = {s}_{7} ( {r}_{{6}_{7}} {x}^{7} ) + {s}_{7} ( {r}_{{6}_{6}} {x}^{6} ) + ⋯ + {s}_{7} ( {r}_{{6}_{0}} )\end{matrix} \qquad Equation 12$$

$$+ {s}_{6} ( {r}_{{5}_{7}} {x}^{7} ) + {s}_{6} ( {r}_{{5}_{6}} {x}^{6} ) + ⋯ + {s}_{6} ( {r}_{{5}_{0}} )$$

$$+ {s}_{0} ( {r}_{{254}_{7}} {x}^{7} ) + {s}_{0} ( {r}_{{254}_{6}} {x}^{6} ) + ⋯ + {s}_{0} ( {r}_{{254}_{0}} )$$

That is, the shift syndrome T₁s(x) may be obtained by multiplying each coefficient of the polynomial syndrome s(x) by the remainders of x⁶~x⁻¹ each divided by g(x) and adding them all up. This means that it may be simplified to a matrix multiplication operation of the syndrome vector s=[s₇, s₆, s₅, s₄, s₃, s₂, s₁, s₀] and a matrix having the coefficients of the remainders of x⁶~x⁻¹ each divided by g(x) as a single row. Therefore, as in Equation 13, after storing a shift matrix M, which has the coefficients of each calculation formula of x⁶ mod g(x),x⁵ mod g(x), . . . , x²⁵⁴ mod g(x) as a single row, the coefficients of the polynomial syndrome T¹s(x) of the error pattern cyclically shifted once may be obtained by multiplying s and M.

$${T}_{s}^{1} ( x ) = {s}_{7}^{′} {x}^{7} + {s}_{6}^{′} {x}^{6} + ⋯ + {s}_{1}^{′} x + {s}_{0}^{′} \qquad Equation 13$$

$${T}_{s}^{1} = [ \begin{matrix}{s}_{7}^{′} & {s}_{6}^{′} & {s}_{5}^{′} & {s}_{4}^{′} & {s}_{3}^{′} & {s}_{2}^{′} & {s}_{1}^{′} & {s}_{0}^{′}\end{matrix} ] = s \cdot M$$

$$M = [ \begin{matrix}{r}_{{6}_{7}} & {r}_{{6}_{6}} & {r}_{{6}_{5}} & {r}_{{6}_{4}} & {r}_{{6}_{3}} & {r}_{{6}_{2}} & {r}_{{6}_{1}} & {r}_{{6}_{0}} \\ {r}_{{5}_{7}} & {r}_{{5}_{6}} & {r}_{{5}_{5}} & {r}_{{5}_{4}} & {r}_{{5}_{3}} & {r}_{{5}_{2}} & {r}_{{5}_{1}} & {r}_{{5}_{0}} \\ {r}_{{4}_{7}} & {r}_{{4}_{6}} & {r}_{{4}_{5}} & {r}_{{4}_{4}} & {r}_{{4}_{3}} & {r}_{{4}_{2}} & {r}_{{4}_{1}} & {r}_{{4}_{0}} \\ {r}_{{3}_{7}} & {r}_{{3}_{6}} & {r}_{{3}_{5}} & {r}_{{3}_{4}} & {r}_{{3}_{3}} & {r}_{{3}_{2}} & {r}_{{3}_{1}} & {r}_{{3}_{0}} \\ {r}_{{2}_{7}} & {r}_{{2}_{6}} & {r}_{{2}_{5}} & {r}_{{2}_{4}} & {r}_{{2}_{3}} & {r}_{{2}_{2}} & {r}_{{2}_{1}} & {r}_{{2}_{0}} \\ {r}_{{1}_{7}} & {r}_{{1}_{6}} & {r}_{{1}_{5}} & {r}_{{1}_{4}} & {r}_{{1}_{3}} & {r}_{{1}_{2}} & {r}_{{1}_{1}} & {r}_{{1}_{0}} \\ {r}_{{0}_{7}} & {r}_{{0}_{6}} & {r}_{{0}_{5}} & {r}_{{0}_{4}} & {r}_{{0}_{3}} & {r}_{{0}_{2}} & {r}_{{0}_{1}} & {r}_{{0}_{0}} \\ {r}_{{254}_{7}} & {r}_{{254}_{6}} & {r}_{{254}_{5}} & {r}_{{254}_{4}} & {r}_{{254}_{3}} & {r}_{{254}_{2}} & {r}_{{254}_{1}} & {r}_{{254}_{0}}\end{matrix} ] = [ \begin{matrix}0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1 \\ {r}_{{254}_{7}} & {r}_{{254}_{6}} & {r}_{{254}_{5}} & {r}_{{254}_{4}} & {r}_{{254}_{3}} & {r}_{{254}_{2}} & {r}_{{254}_{1}} & {r}_{{254}_{0}}\end{matrix} ]$$

Furthermore, since the polynomial syndrome T²s shifted twice is the same as T¹s shifted once more, it may be obtained by multiplying by M once more as in Equation 14.

$${T}_{s}^{2} = {T}_{s}^{1} \cdot M = s \cdot M \cdot M = s \cdot {M}^{2} \qquad Equation 14$$

Therefore, the syndrome T^{8h}s shifted 8 h times may be calculated through matrix multiplication as in Equation 15 below, and the shift matrix M^{8h} used here may be pre-calculated and stored.

$${T}^{8 h} s = s \cdot {M}^{8 h} \qquad Equation 15$$

The syndrome shift calculation may be performed with one matrix multiplication as described above, and it is also possible to calculate the shifted syndromes T⁸s,T¹⁶s,T²⁴s,T⁸²s from the input s in parallel. The calculation result is delivered to the horizontal error detector 423.

The horizontal error detector 423 receives the polynomial syndrome from the syndrome shift calculator 422, outputs an expected error pattern ê(x), and operates in parallel for each syndrome. It detects the presence of a horizontal error and the corresponding error pattern according to the result of a detector function D(T^{8h}s) which detects whether the received syndrome corresponds to a single-chip horizontal error. When T⁰s=s, this detection process proceeds as follows.
1) If TRUE exists among the results of D(T^{8h}s), 0≤h≤4, the horizontal error is detected as in Equation 16 by reverse shifting the input syndrome T^{8h}s.

$$\hat{e} ( x ) = {T}^{8 h} s ( x ) \cdot {x}^{8 h} \qquad Equation 16$$

2) If all results of D(T^{8h}s), 0≤h≤4 are FALSE, it is determined that no horizontal error exists, and no error correction is performed as in Equation 17.

$$\hat{e} ( x ) = 0 \qquad Equation 17$$

The result of the detector function D(T^{8h}s) is determined through the following process. The symbol values of the syndrome are observed, and the non-zero symbol values are stored. If the number of types is 4 or more, it is determined that it is not an SHE or DHE. If it is 2 or less, it is determined that it corresponds to an SHE or DHE. If the number of types is 3, it is confirmed whether the sum of the first and second stored symbol values matches the third symbol value. If it matches, it is determined that it corresponds to a DUE, and if it does not match, it is determined that it does not correspond. When the set of symbol values stored by the horizontal error detector 423 is V_{sym}, the detection process is as follows.
1) The horizontal error detector 423 stores the non-zero symbol values of the input syndrome by type as in Equation 18.

$${V}_{sym} = \{ {α}^{{l}_{1}} , … , {α}^{{l}_{k}} \} , 1 \leq k \leq 8 \qquad Equation 18$$

2) If the number of types of non-zero symbols in the syndrome is 4 or more, the horizontal error detector determines that the syndrome is not a syndrome of a horizontal error as in Equation 19.

$$n ( {V}_{sym} ) \geq 4 \to D ( {T}^{8 h} s ) = FALSE \qquad Equation 19$$

3) If the number of types of non-zero symbols in the syndrome is 2 or less, it is determined that it corresponds to an SHE or DHE error as in Equation 20.

$$n ( {V}_{sym} ) \leq 2 \to D ( {T}^{8 h} s ) = TRUE \qquad Equation 20$$

4) If the number of types of non-zero symbols in the syndrome is 3, and if the third type of symbol value matches the sum of the other two symbol values, the horizontal error detector determines that the syndrome corresponds to a DUE error as in Equation 21. If the third type of symbol value does not match the sum of the other two symbol values, it is determined that it is not a syndrome of a horizontal error as in Equation 22.

$${α}^{{i}_{s}} = {α}^{{i}_{1}} + {α}^{{i}_{2}} \to D ( {T}^{8 h} s ) = TRUE \qquad Equation 21$$

$${α}^{{i}_{s}} \neq {α}^{{i}_{1}} + {α}^{{i}_{2}} \to D ( {T}^{8 h} s ) = FALSE \qquad Equation 22$$

Through this process, an SHE or DHE error pattern may be detected and obtained. The expected error pattern thus obtained is delivered to the error corrector 424 and used to correct the error.

The error corrector 424 is a part which performs error correction by subtracting the [symbol] expected error pattern ê from the received codeword y. The message [symbol] , which excludes parity from the error-corrected expected codeword ĉ, is output as the final result of the horizontal error decoder.

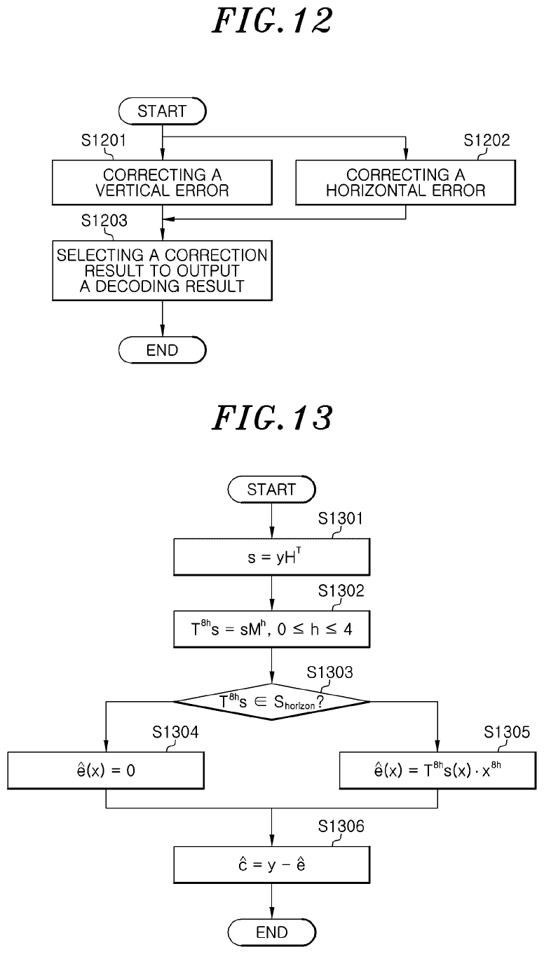

FIG. 12 is a flowchart of a row and column error control RL-ECC decoding method according to an embodiment of the present disclosure, and FIG. 13 is a flowchart of a horizontal error correction decoding based on an RS code.

A step of receiving a codeword as an input and correcting a vertical error of t symbols or less of an RS code (S1201) and a step of receiving the codeword as input and correcting a horizontal error of t+1 symbols or more (S1202) are performed in parallel. Thereafter, an operation of selecting one of a correction result for t symbols or less and a correction result for t+1 symbols or more to output a decoding result (S1203) is performed.

The operation of correcting a horizontal error (S1202) includes calculating a syndrome polynomial from the codeword (S1301), calculating a shift syndrome (S1302), confirming whether the horizontal error condition for each syndrome is satisfied (S1303), and if a syndrome satisfying the condition exists, calculating an error pattern by multiplying that syndrome by x^{8h} (S1305, S1306), and if no syndrome satisfying the condition exists, determining that no horizontal error has occurred and returning the codeword y(x) as it is (S1304, S1306).

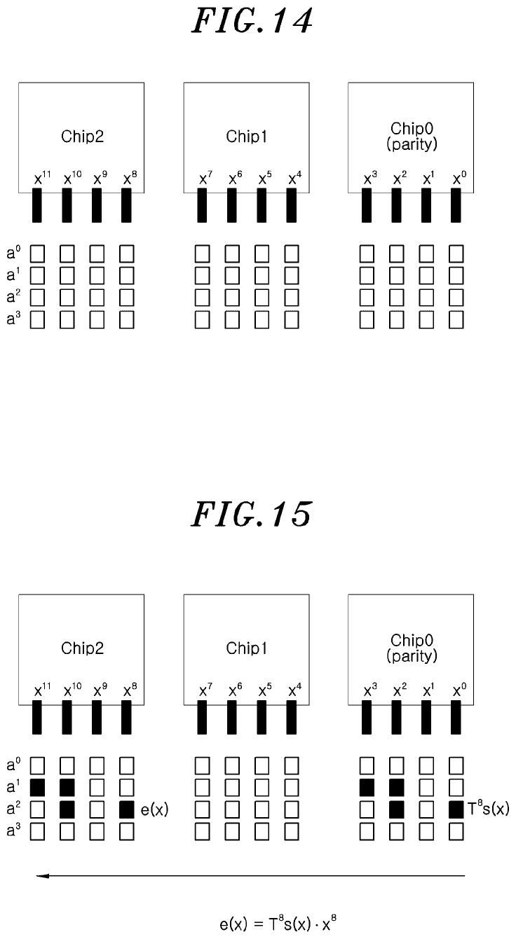

FIG. 14 is an example of a horizontal error control RL-ECC, and FIG. 15 is an example of an error pattern calculation through reverse shifting.

Consider a DIMM composed of three ×4 DRAM chips. When two chips are used as data chips and the other one as a parity chip, if an RS code is applied by grouping 4 bits from one pin into one symbol, the length is 15 and the number of parity symbols is 4, so a 15,11 length 2-symbol error correction RS code is designed. Here, since the actual number of pins is 12, a 12,8 length shortened RS code is applied by shortening by 3 to match the codeword length. This means that the actually transmitted data is 12 symbols out of 15, and the remaining 3 symbols are not transmitted but are fixed to 0 and processed in the encoding/decoding process.

When storing a message u(x) composed of 8 symbols in a DRAM using this RL-ECC, a codeword c(x) with 4 parity symbols added is obtained by multiplying by the generator polynomial g(x)=x⁶+α¹⁰x⁵+α¹⁴x⁴+α⁴x³+α⁶x²+α⁹x+α⁶ of the 12,8 shortened RS code, and a total of 12 symbols are stored by dividing one symbol into 4 bits for each pin. When reading this data, 12 symbols are obtained again by grouping the 4 bits read from each pin into one symbol, and an error-corrected message û(x) is obtained through a decoding process. Assuming an arbitrary u(x) for an example, c(x) is calculated as in Equation 23 below.

$$\begin{matrix}u ( x ) & = {α}^{12} {x}^{7} + {α}^{3} {x}^{6} + {α}^{8} {x}^{5} + {α}^{6} {x}^{4} + {α}^{2} {x}^{3} + α x + 1 \\ g ( x ) & = {x}^{4} + {α}^{13} {x}^{3} + {α}^{6} {x}^{2} + {α}^{3} x + {α}^{10} \\ c ( x ) & = u ( x ) \cdot {x}^{4} + u ( x ) \cdot {x}^{4} mod g ( x ) \\ & = {α}^{12} {x}^{11} + {α}^{3} {x}^{10} + {α}^{8} {x}^{9} + {α}^{6} {x}^{8} + {α}^{2} {x}^{7} + α {x}^{5} + {x}^{4} + {α}^{12} {x}^{7} + {α}^{3} {x}^{6} + {α}^{8} {x}^{5} + {α}^{6} {x}^{4} + {α}^{8} {x}^{3} + {α}^{12} {x}^{7} + {α}^{3} {x}^{6} + {α}^{8} {x}^{5} + {α}^{6} {x}^{4} + {α}^{3} {x}^{2} + {α}^{12} {x}^{7} + {α}^{3} {x}^{6} + {α}^{8} {x}^{5} + {α}^{6} {x}^{4} + {α}^{3}\end{matrix} \qquad Equation 23$$

At this time, if an abnormality occurs in the DQS signal of the first chip as in FIG. 14, causing the moment of reading the second symbol to be wrong and resulting in an SHE which causes 3 bit errors, the error pattern e(x) of this SHE and the corresponding received codeword y(x) are expressed as in Equation 24 below.

$$\begin{matrix}e ( x ) & = α {x}^{11} + {α}^{5} {x}^{10} + {α}^{2} {x}^{8} \\ y ( x ) & = c ( x ) + e ( x ) \\ & = {α}^{13} {x}^{11} + {α}^{11} {x}^{10} + {α}^{8} {x}^{9} + {α}^{3} {x}^{8} + {α}^{2} {x}^{7} + α {x}^{5} + {x}^{4} + {α}^{8} {x}^{3} + {α}^{3} {x}^{2} + {α}^{3}\end{matrix} \qquad Equation 24$$

The received codeword y(x) is delivered as input to two decoders operating in parallel, the RS decoder 410 and the horizontal error decoder 420. Since the RS decoder 410 cannot correct errors exceeding 2 symbols, it delivers a signal indicating which decoding has failed.

Simultaneously, in the horizontal error decoder 420, the syndrome calculator first calculates the syndrome polynomial s(x)=y(x) mod g(x)=s₃x³+s₂x²+s₁x+s₀ from the received codeword, which may be simply obtained by matrix multiplication as in Equation 25, using the fact that the syndrome codeword s=[s₃, s₂, s₁, s₀]=yH^{T}. At this time, H^{T*} is a matrix having the coefficients of the remainders of x¹¹, x¹⁰, . . . , x⁰ each divided by g(x) as a single row.

$$y = [ \begin{matrix}{α}^{13} & {α}^{11} & {α}^{8} & {α}^{3} & {α}^{2} & 0 & {α}^{1} & 1 & {α}^{8} & {α}^{3} & 0 & {α}^{3}\end{matrix} ] \qquad Equation 25$$

$${H}^{T} = [ \begin{matrix}{α}^{6} & {α}^{13} & {α}^{3} & {α}^{5} \\ {α}^{10} & {α}^{14} & {α}^{12} & {α}^{8} \\ {α}^{13} & {α}^{14} & {α}^{9} & {α}^{13} \\ {α}^{3} & {α}^{12} & {α}^{4} & {α}^{5} \\ {α}^{10} & {α}^{13} & {α}^{13} & {α}^{11} \\ {α}^{1} & {α}^{11} & {α}^{5} & {α}^{11} \\ {α}^{1} & {α}^{7} & {α}^{8} & {α}^{8} \\ {α}^{13} & {α}^{6} & {α}^{3} & {α}^{10} \\ 1 & 0 & 0 & 0 \\ 0 & 1 & 0 & 0 \\ 0 & 0 & 1 & 0 \\ 0 & 0 & 0 & 1\end{matrix} ]$$

$$s = {yH}^{T} = [ \begin{matrix}{α}^{6} & {α}^{4} & {α}^{7} & {α}^{9}\end{matrix} ]$$

As a result of the calculation, the syndrome vector s is obtained and delivered to the syndrome shift calculator 422, and the syndrome shift calculator 422 calculates the shift syndromes T⁴s, T⁸s using s. This corresponds to the syndrome when the error pattern is shifted by x⁻⁴, x⁻⁸. In this example, since the number of chips is 3, the maximum number of shifts is 2, so the horizontal error may be corrected by checking only two shift syndromes. This operation may be calculated through a matrix multiplication of the syndrome vector s and the shift matrix M^{4h}, and the shift matrix M is obtained and stored in advance as in Equation 26 below.

$${x}^{2} mod g ( x ) = {x}^{2} \qquad Equation 26$$

$${x}^{1} mod g ( x ) = x$$

$${x}^{0} mod g ( x ) = 1$$

$${x}^{14} mod g ( x ) = {α}^{5} {x}^{3} + {α}^{3} {x}^{2} + {α}^{11} x + {α}^{8}$$

$$M = [ \begin{matrix}0 & 1 & 0 & 0 \\ 0 & 0 & 1 & 0 \\ 0 & 0 & 0 & 1 \\ {α}^{5} & {α}^{3} & {α}^{11} & {α}^{8}\end{matrix} ]$$

$${T}_{s}^{4} = [ \begin{matrix}{α}^{4} & {α}^{11} & {α}^{3} & {α}^{1}\end{matrix} ]$$

$${T}_{s}^{8} = [ \begin{matrix}{α}^{1} & {α}^{5} & 0 & {α}^{2}\end{matrix} ]$$

Both the syndrome and the shift syndromes are delivered to the horizontal error detector 423 to check if any of these syndromes correspond to a syndrome of a horizontal error. This may be confirmed using the symbol value characteristics of the horizontal error. In this case, it may be known that T⁸s corresponds to the syndrome of a DUE because the number of types of non-zero symbols in the syndrome is 3, and it satisfies the condition which the third type of symbol value is equal to the sum of the other two symbol values, α₁+α⁵=α². Therefore, at this time, the shifted error pattern e(x)⁻⁸ becomes αx³+αx²+α², which is identical to the syndrome, and the original error pattern may be obtained by reverse shifting by x⁸ again, as ê(x)=αx¹¹+α⁵x¹⁰+α²x⁸. Finally, the process ends by correcting the error by subtracting ê(x) from the received codeword y(x) as in Equation 27.

$$\hat{e} ( x ) = y ( x ) - \hat{e} ( x ) = {α}^{12} {x}^{11} + {α}^{1} {x}^{10} + {α}^{8} {x}^{9} + {α}^{6} {x}^{8} + {α}^{2} {x}^{7} + α {x}^{5} + {x}^{4} + {α}^{8} {x}^{3} + {α}^{3} {x}^{2} + {α}^{3} \qquad Equation 27$$

As described so far, according to an embodiment of the present disclosure, a rank-level ECC decoding apparatus and a method thereof are provided, which are capable of correcting a vertical error and a horizontal error based on an RS code. According to an embodiment, horizontal errors may be corrected while maintaining a conventional encoding process by using a polynomial syndrome of an RS code and a result of a polynomial modulo operation. Horizontal errors may be additionally controlled in addition to the vertical error correction capability of a conventional RS code without additional parity and time delay. By correcting horizontal errors within one chip using an RS code without using a syndrome-error pattern mapping table, it may be operated in parallel with a conventional RS code decoder, and as a result, horizontal errors within one chip may be additionally corrected without additional parity or time delay.

Meanwhile, each step included in the row and column error control RL-ECC decoding method according to the aforementioned embodiment may be implemented as a computer program recorded on a storage medium, including instructions for causing a processor to perform these steps.

The combinations of each operation of each flowchart attached to the present disclosure may also be performed by computer program instructions. These computer program instructions may be loaded onto a processor of a general-purpose computer, a special-purpose computer, or other programmable data processing equipment, so the instructions performed through the processor of the computer or other programmable data processing equipment create means for performing the functions described in each step of the flowchart. These computer program instructions may also be stored in a computer-usable or non-transitory computer-readable storage medium which may direct a computer or other programmable data processing equipment to implement functions in a specific way, so the instructions stored in the computer-usable or non-transitory computer-readable storage medium may also produce an article of manufacture including instruction means which performs the functions described in each step of the flowchart. The computer program instructions may also be loaded onto a computer or other programmable data processing equipment, so a series of operational steps are performed on the computer or other programmable data processing equipment to create a computer-executed process, so the instructions which execute the computer or other programmable data processing equipment may also provide steps for executing the functions described in each step of the flowchart.

Furthermore, each step may represent a module, segment, or part of a code including one or more executable instructions for executing a specified logical function(s). It should also be noted which in some alternative embodiments, the functions mentioned in the steps may occur out of order. For example, two steps shown in succession may in fact be performed substantially simultaneously, or the steps may sometimes be performed in reverse order, depending on the corresponding function.

The above description is merely illustrative of the technical idea of the present disclosure, and various modifications and variations will be possible by those of ordinary skill in the art to which the present disclosure pertains without departing from the essential qualities of the present disclosure. Therefore, the embodiments disclosed in the present disclosure are not for limiting the technical idea of the present disclosure, but for describing it, and the scope of the technical idea of the present disclosure is not limited by these embodiments. The protection scope of the present disclosure should be interpreted by the claims below, and all technical ideas within the scope equivalent thereto should be interpreted as being included in the scope of rights of the present disclosure.

What is claimed is:

1. A row and column error control RL-ECC (rank-level ECC) decoding apparatus, comprising:
an RS decoder configured to receive a codeword as an input and to correct a vertical error (an error occurring in the column direction of an RS (Reed-Solomon) code's codeword array) of t symbols or less of the RS code;
a horizontal error decoder configured to receive the codeword as input and to correct a horizontal error (an error occurring in a row direction of the RS code's codeword array) of t+1 symbols or more; and
a decoding output selector configured to select, based on a decoding result signal, one among an output of the RS decoder and an output of the horizontal error decoder to output a decoding result of the RS decoder;
wherein the decoding output selector selects the output of the RS decoder if the decoding result signal represents that decoding is successful, and selects the output of the horizontal error decoder if the decoding result signal represents that the decoding fails, and when both the output of the RS decoder and the output of the horizontal error decoder exist, the decoding result signal represents that the decoding is successful so that the decoding output selector selects the output of the RS decoder to output the decoding result.

2. The row and column error control RL-ECC decoding apparatus of claim 1, wherein the horizontal error decoder includes:
a polynomial syndrome calculator configured to calculate a polynomial syndrome for the codeword;
a syndrome shift calculator configured to calculate a syndrome of a cyclically shifted error pattern for the calculated polynomial syndrome;
a horizontal error detector configured to detect and derive a horizontal error for the calculated syndrome of the error pattern; and
an error corrector configured to correct the detected and derived horizontal error.

3. The row and column error control RL-ECC decoding apparatus of claim 2, wherein the polynomial syndrome calculator receives a codeword vector y as input, performs a matrix multiplication of y and a transpose matrix H^{T} of a parity check matrix (PCM) H to calculate a syndrome vector s, and provides the syndrome vector s to the syndrome shift calculator and the horizontal error detector.

4. The row and column error control RL-ECC decoding apparatus of claim 2, wherein the syndrome shift calculator obtains the cyclically shifted syndrome by using a syndrome shift property for calculating a polynomial syndrome corresponding to a cyclically shifted error pattern through the polynomial syndrome for an arbitrary error pattern.

5. A row and column error control RL-ECC (rank-level ECC) decoding method to be performed by a row and column error control RL-ECC decoding apparatus, the method comprising:
correcting a vertical error (an error occurring in the column direction of an RS code's codeword array) of t symbols or less of the RS code by receiving a codeword as input;
correcting a horizontal error (an error occurring in the row direction of the RS code's codeword array) of t+1 symbols or more by receiving the codeword as input; and
selecting, based on a decoding result signal, one among a correction result for the t symbols or less and a correction result for the t+1 symbols or more to output a decoding result;
wherein, when outputting the decoding result, if the decoding result signal represents that decoding is successful, the correction result for the vertical error is selected as the decoding result, and if the decoding result signal represents that the decoding fails, the correction result for the horizontal error is selected as the decoding result, and when both the correction result for the vertical error and the correction result for the horizontal error exist, the decoding result signal represents that the decoding is successful so that the correction result for the vertical error is selected as the decoding result.

6. The row and column error control RL-ECC decoding method of claim 5, wherein the correcting of the horizontal error includes:
calculating a polynomial syndrome for the codeword;
calculating a syndrome of a cyclically shifted error pattern for the calculated polynomial syndrome;
detecting and deriving a horizontal error for the calculated syndrome of the error pattern; and
correcting the detected and derived horizontal error.

7. The row and column error control RL-ECC decoding method of claim 6, wherein the calculating of the polynomial syndrome includes calculating a syndrome vector s by receiving a codeword vector y as input and performing a matrix multiplication of y and a transpose matrix H^{T} of a parity check matrix (PCM) H.

8. The row and column error control RL-ECC decoding method of claim 6, wherein the calculating of the syndrome of the cyclically shifted error pattern includes obtaining the syndrome of the cyclically shifted error pattern by using a syndrome shift property for calculating a polynomial syndrome corresponding to a cyclically shifted error pattern through a polynomial syndrome for an arbitrary error pattern.

9. A non-transitory computer-readable storage medium on which a computer program is stored, wherein the computer program, when executed by a processor, comprises instructions executable to cause the processor to perform a row and column error control RL-ECC (rank-level ECC) decoding method, the method comprising:
correcting a vertical error (an error occurring in the column direction of an RS code's codeword array) of t symbols or less of the RS code by receiving a codeword as input;
correcting a horizontal error (an error occurring in the row direction of the RS code's codeword array) of t+1 symbols or more by receiving the codeword as input; and
selecting, based on a decoding result signal, one among a correction result for the t symbols or less and a correction result for the t+1 symbols or more to output a decoding result;
wherein, when outputting the decoding result, if the decoding result signal represents that decoding is successful, the correction result for the vertical error is selected as the decoding result, and if the decoding result signal represents that the decoding fails, the correction result for the horizontal error is selected as the decoding result, and when both the correction result for the vertical error and the correction result for the horizontal error exist, the decoding result signal represents that the decoding is successful so that the correction result for the vertical error is selected as the decoding result.

10. The non-transitory computer-readable storage medium on which a computer program is stored of claim 9, wherein the correcting of the horizontal error includes:
calculating a polynomial syndrome for the codeword;
calculating a syndrome of a cyclically shifted error pattern for the calculated polynomial syndrome;
detecting and deriving a horizontal error for the calculated syndrome of the error pattern; and
correcting the detected and derived horizontal error.

11. The non-transitory computer-readable storage medium on which a computer program is stored of claim 10, wherein the calculating of the polynomial syndrome includes calculating a syndrome vector s by receiving a codeword vector y as input and performing a matrix multiplication of y and a transpose matrix H^{T} of a parity check matrix (PCM) H.

12. The non-transitory computer-readable storage medium on which a computer program is stored of claim 10, wherein the calculating of the syndrome of the cyclically shifted error pattern includes obtaining the syndrome of the cyclically shifted error pattern by using a syndrome shift property for calculating a polynomial syndrome corresponding to a cyclically shifted error pattern through a polynomial syndrome for an arbitrary error pattern.
